(19) United States
(12) Patent Application Publication
(10) Pub. No.: US 2026/0298061 A1
(43) Pub. Date: Oct. 1, 2026

(54) METHOD FOR DETERMINING FRACTURE TREATMENT UNIFORMITY INDEX FROM TUBE WAVES INDUCED IN A WELL

(71) Applicant: Seismos, Inc., Austin, TX (US)

(72) Inventors: Saeed Rahimi-Aghdam, Austin, TX (US); Ibrahim Said Abou-Sayed, Sugar Land, TX (US)

(21) Appl. No.: 19/665,225

(22) Filed: May 1, 2026

Related U.S. Application Data
(63) Continuation of application No. PCT/US2024/054311, filed on Nov. 2, 2024.
(60) Provisional application No. 63/595,829, filed on Nov. 3, 2023.
(60) Provisional application No. 63/659,849, filed on Jun. 14, 2024.

(51) Int. Cl. E21B 43/26; E21B 49/00

(52) U.S. Cl. CPC E21B 43/26; E21B 49/008; E21B 2200/20

(57) ABSTRACT

A method for determining uniformity index (UI) of a fracture treatment includes measuring pressure and fluid flow rate in a well during pumping the fracture treatment. For at least one change in flow rate of the pumping, well pipe friction pressure loss is determined or estimated and perforation friction pressure loss is determined using tube wave events in the measured pressure induced by the change in flow rate. A perforation efficiency is determined using the perforation friction pressure loss and an expected perforation friction pressure loss. A volume of fluid accepted by each of a plurality of perforation clusters in the well pipe is determined using the perforation efficiency. The determined volumes are used to calculate the UI.

### CROSS REFERENCE TO RELATED APPLICATIONS

Continuation of International Application No. PCT/US2024/054311 filed on Nov. 2, 2024. Priority is claimed from US Provisional Applications Nos. 63/595,829 filed on Nov. 3, 2023 and 63/659,849 filed on Jun. 14, 2024. All the foregoing applications are incorporated herein by reference in their entireties.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of treatment of subsurface wells used to extract valuable minerals such as hydrocarbons from subsurface formations. More particularly, the present disclosure relates to specific uses for parameters determinable using pressure measurements made during pumping fluid treatments such as hydraulic fracturing treatments used to enhance production rates and fluid recovery from such wells.

US Patent Application Publication No. 2023/0228185 filed by Dunham et al. discloses a method for using induced tube waves caused by flow rate changes of fluid in a pipe (a well) to determine frictional fluid pressure loss along the pipe and through perforations in the pipe that connect the well hydraulically to formations outside the well. By being able to calculate such frictional fluid pressure losses, it is possible to determine the fluid pressure at the mouth of one or more fractures in the formations. Such pressure is important in conducting and evaluating hydraulic fracture treatment parameters such as fluid density, fluid viscosity, pumping rate, pumping pressure and proppant concentration during pumping.

Such friction pressure losses may be used to determine further properties of the well and the surrounding formations.

A parameter of interest in hydraulic fracturing treatment operations is the uniformity index (UI), which is a measure of fractional amounts of the total fluid volume being pumped into each of a plurality of perforation clusters (plurality of groups of closely spaced apart openings in the well casing or liner, such groups being more widely spaced apart) in a “stage” (axial interval) of a fracture treatment. Methods known in the art for determining UI include placing optical fiber sensors outside the well casing or liner at the time such liner is “run” during well construction. In addition to the cost of such sensors, there is some risk of sensor failure during running or afterward.

It is desirable to have a method for determining UI that does not require special sensors such as are needed using techniques known in the art.

### SUMMARY

One aspect of the present disclosure is a method for determining uniformity index (UI) of a fracture treatment. A method according to this aspect includes measuring pressure and fluid flow rate in a well during pumping the fracture treatment. For at least one change in flow rate of the pumping, well pipe friction pressure loss is determined or estimated and perforation friction pressure loss is determined using tube wave events in the measured pressure induced by the change in flow rate. A perforation efficiency is determined using the perforation friction pressure loss and an expected perforation friction pressure loss. A volume of fluid accepted by each of a plurality of perforation clusters in the well pipe is determined using the perforation efficiency. The determined volumes are used to calculate the UI.

In another aspect of this disclosure, a non-transitory computer readable medium has stored thereon logic operable to cause a programmable computer to perform actions according to the above-described method, wherein measurements of pressure and fluid flow rate in the well are accepted as input to the programmable computer.

Some implementations further comprise repeating the determining or estimating well pipe friction pressure loss and the determining perforation friction pressure loss, repeating the determining perforation efficiency, repeating the determining volume of fluid and repeating the calculating UI for each of a plurality of changes in flow rate during the pumping the fracture treatment.

Some implementations further comprise repeating the determining or estimating well pipe friction pressure loss and the determining perforation friction pressure loss, repeating the determining perforation efficiency, repeating the determining volume of fluid and repeating the calculating UI for each of a plurality of changes in flow rate for each of a plurality of fracture treatment stages in the well.

In some implementations, the perforation efficiency is determined as a number of perforations through which fluid is flowing with respect to a total number of perforations in the well pipe.

In some implementations, the fluid volume for each of the plurality of perforation clusters is determined by the perforation efficiency and a total number of perforations in each of the plurality of perforation clusters.

Other aspects and possible advantages will be apparent from the description and claims that follow.

### BRIEF DESCRIPTION OF THE DRAWINGS

FIG. 1 shows example implementations of equipment that may be used to acquire signals usable with a method according to the present disclosure.

FIG. 2 illustrates the meaning of uniformity index (UI).

FIG. 3 shows a graph with respect to time during pumping a fracture treatment of pressure, volume of proppant and frac fluid pumping rate.

FIG. 4 shows a graph of perforation efficiency with respect to time during pumping of a fracture treatment.

FIG. 5 shows a graph of volumes of fracture fluid accepted by each of a plurality of perforation clusters in a fracture treatment stage and an associated UI.

FIG. 6 shows an example computer system that may be used in accordance with a method of the present disclosure.

### DETAILED DESCRIPTION

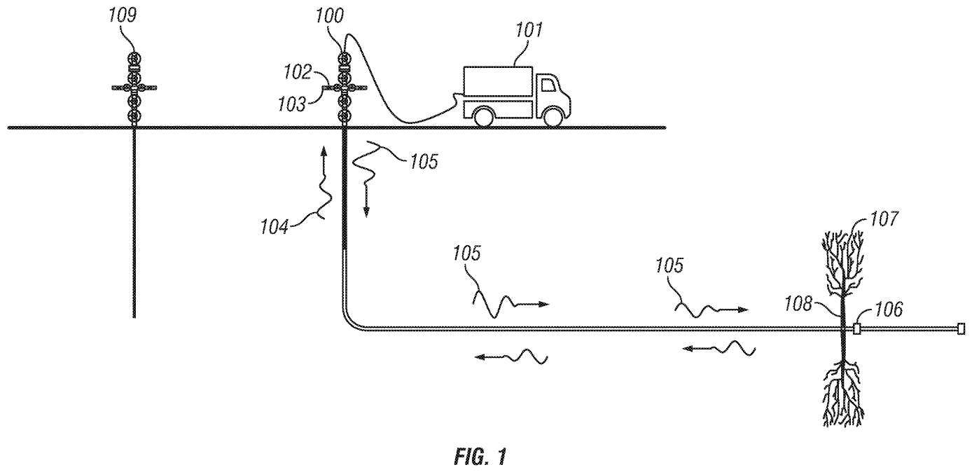

FIG. 1 is a schematic diagram of an example well data acquisition system (“system”) that may be used in some implementations. The system 100 comprises components associated with a well including fluid pump(s) 101, such as hydraulic fracturing fluid pumps or other fluid treatment pumps; sensors such as hydrophones or pressure transducers 102 in fluid pressure communication with the well; a data acquisition and processing apparatus 103 (described in more detail below); a well pipe 104, e.g., a casing or liner disposed in a well drilled through a reservoir formation; a plug or wellbore bottom 106; fracture network 107 in hydraulic communication with the well through perforations 108 made in the well pipe (e.g., casing or liner) 104. A nearby well 109 may be present in the area of interest. One or more water hammer pulses 105 may be generated by the pumps 101, such as by a step change in the rate of pumping, or a pressure pulse may be generated by other means such as a fluid pressure pulse generator. The pulse(s) travel along the well in the form of tube waves. The sensors 102 may be nonintrusive devices such as pressure transducers, accelerometers, and hydrophone(s), any or all of which may be disposed in a location on or near the top of the well (e.g., the wellhead) to measure pressure, pressure time derivative and/or particle motion of fluid in the well continuously before, during, and after pumping of a treatment such as an hydraulic fracture treatment. Characteristics of such data may be analyzed as explained below to obtain parameters such as frictional pressure loss along the well and through the perforations also as will be explained in more detail below.

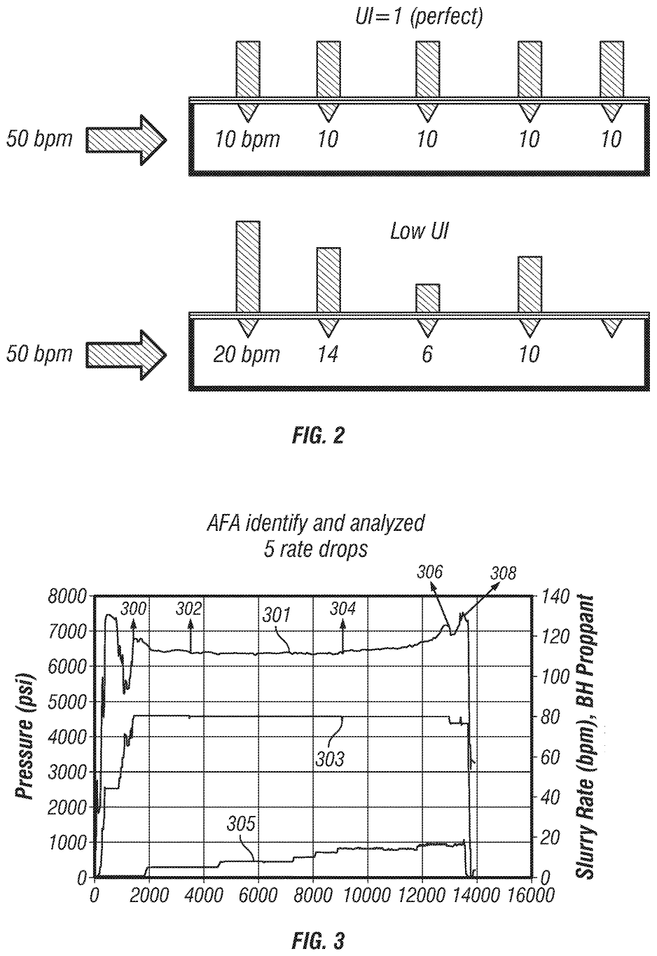

One attribute of pumping a treatment such as a fracture treatment is that fluid being pumped into a specific axial interval in the well (a “stage”) may include variations between fluid movement rates among spaced apart groups (“clusters”) of perforations, in each of which are a number of perforations spaced apart by relatively small distances (e.g., 1 to 6 inches). The clusters may be separated from each other by several feet to several tens of feet. Thus, some clusters may accept relatively large fractions of the total fluid flow, while others may accept little to none. FIG. 2 illustrates the principle. In the upper part of FIG. 2, all perforation clusters in a stage accept the same fractional amount (e.g., 10 barrels/min) of a total fluid pumping rate (e.g., 50 barrels/min). A “uniformity index” (UI) in such case is unity (1). The lower part of FIG. 2 illustrates that the various perforation clusters accept differing fractional amounts of the total fluid flow. In such case the UI will be less than unity.

During pumping of treatments such as hydraulic fracture treatments, fluid properties and fluid pumping rates may be changed to cause the fluid pumping to obtain specific results. In FIG. 3, such changes in the pumping rate and accompanying fluid pressure at 301 may take place at the initiation of a first pad segment 300, during proppant pumping at 302, 304 and 306, until the end of the fracture stage pumping at 308. Corresponding fluid flow rates are shown at 303, and cumulative volumes of proppant are shown at curve 305.

As will be readily apparent from the disclosure in US Pat. App. Pub. No. 2023/0228185 filed by Durham et al. and incorporated herein by reference, each such flow rate change and accompanying pressure change may induce tube waves in the well (104 in FIG. 1). Characteristics of the tube waves may be used, as explained in the '185 publication, to determine frictional pressure loss in the well pipe and in the perforations. Thus, during pumping a fracture treatment stage at varying flow rates, it is possible to determine pipe and perforation friction at each of such times over the course of pumping the fracture stage.

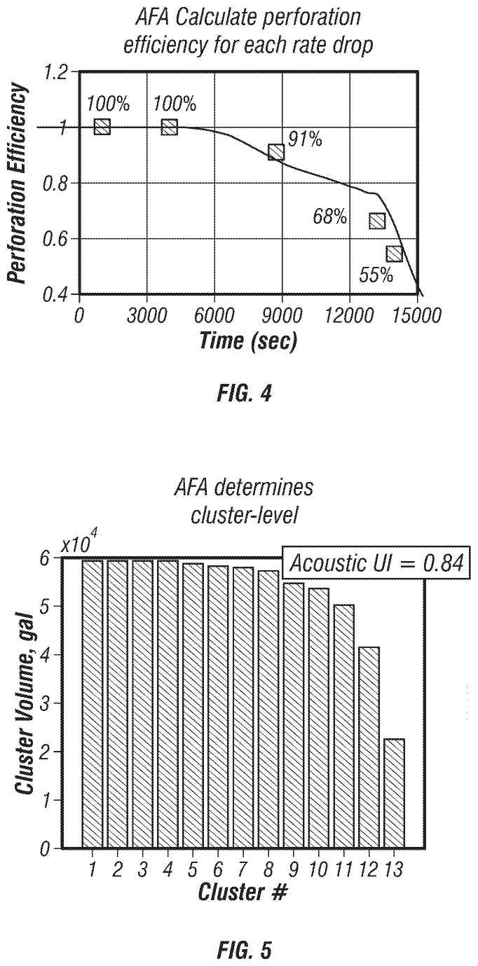

FIG. 4 illustrates that for each flow rate change, and accompanying calculation of pipe friction pressure loss and perforation friction pressure loss as shown in FIG. 3, it is possible to calculate a perforation efficiency. Perforation efficiency represents how many of the perforations in the stage being pumped are taking fluid or are active (perforation efficiency=number of active perforations/total perforations). In the present method, the perforation frictional pressure loss is calculated using the method disclosed in the '185 publication, and the foregoing is compared to the ideal perforation friction loss. Ideal perforation frictional pressure loss is what would be expected if all the perforations were taking fluid. Such expected fluid pressure loss may be calculated using mathematical models of fluid flow through various size apertures with reference to the hydraulic properties of the fluid being pumped. If the number of perforations that take fluid is less than all perforations, then the perforation friction loss will be larger. How much larger will determine the perforation efficiency as follows:

$$Perforation efficiency = {( \frac{ideal perforation friction pressure loss}{perforation friction pressure loss} )}^{0.5} \qquad ( 1 )$$

The foregoing perforation efficiency may be used in determining the UI. In a method according to the present disclosure, the UI may be determined as follows.

The method for determining pipe friction pressure loss and perforation friction pressure loss as set forth in the '185 publication may be performed during a fracture stage for a plurality of pumping rate changes. Other methods for determining pipe friction pressure loss may be used. One such method is to measure pressure at the bottom of the well and use the difference between surface pressure and bottom hole pressure to determine pressure loss as a result of pipe friction. Another method is to estimate pipe friction using known relationships and experimental data on the impact of flow rate and of any friction reducers on friction factor; such method is known in the art when analyzing step rate tests. See, for example, Hydraulic Fracture Mechanics, Peter Valko, Michael J. Economides, ISBN: 978-0-471-95664-8, Wiley, 320 pages, 1996. Another reference for such friction pressure loss determination is, Hydraulic Fracturing: Fundamentals and Advancements, Edited by Jennifer L. Miskimins Society of Petroleum Engineers, (2019) DOI: https://doi.org/10.2118/9781613997192, ISBN electronic: 978-1-61399-904-2, Publication date: 2019.

Perforation efficiency may be calculated each time the frictional pressure losses are determined during the stage, using, e.g., the above formula. Such multiple calculation of perforation efficiency enables determining the variation of perforation efficiency over the entire fracture treatment stage.

The perforation efficiency determinations and the fracture treatment total injected fluid volume data are used to determine the evolution of the fluid volume for each perforation cluster in the stage Vi.

Use the cluster-level volumes Vi to determine a proxy for the uniformity of each fracture stage using the following expression:

$$UI = 1 - STD ( Vi ) / ( mean ( Vi ) ) \qquad ( 2 )$$

where STD is the standard deviation.

The fluid volume taken through each perforation cluster Vi may be obtained as follows. The perforation efficiency values calculated as above will be used to calculate the number of the effective perforations, Nperf_{eff} at any time during pumping.

$${Nperf}_{eff} ( t ) = eperf ( t ) * {N}_{perf} \qquad ( 3 )$$

where eperf is the perforation efficiency, and N_{perf} is the total number of perforations within the entire stage. Here it is assumed all the perforations are the same hydraulically, and it is not known which of the perforations in the stage and various clusters are effective; it is known from eperf only how many of the total number of perforations are taking fluid. With the number of how many of the perforations are taking fluid, it is possible to calculate the slurry volume increment for each perforation.

$$Δ {V}_{perf}^{eff} ( t ) = \frac{Δ {V}_{tot} ( t )}{{Nperf}_{eff} ( t )} \qquad ( 4 )$$

Where ΔVₜₒₜ(t) is total slurry volume pumped at each time increment (e.g., 1 second) and

$$Δ {V}_{perf}^{eff}$$

is the slurry volume increment for each perforation. Note that only effective perforations are taking fluid, and the fluid volume attributable to the inactive perforations remains constant

$$( Δ {V}_{perf}^{inactive} = 0 ) .$$

Now that the volume contribution for each perforation is determinable, it is then possible calculate the volume attributable to each effective perforation at the end of each time increment (Δt) as follows:

$${V}_{perf}^{1 : {Nperf}_{eff}} ( t + Δ t ) = {V}_{perf}^{1 : {Nperf}_{eff}} ( t ) + Δ {V}_{perf}^{eff} ( t ) \qquad ( 5 )$$

$${V}_{perf}^{{Nprf}_{eff} : {N}_{perf}} ( t + Δ t ) = {V}_{perf}^{{Nperf}_{eff} : {N}_{perf}} ( t ) \qquad ( 6 )$$

Finally, the volume of fluid accepted by each of the perforations may be used to calculate the volume of fluid accepted by each cluster in the stage by adding the volumes of all the perforations within each cluster. Expressed alternatively, the individual perforation fluid volumes may be multiplied by the number of perforations in a specific cluster to obtain the fluid volume for such cluster.

FIG. 5 shows an example calculation of cluster level volumes and the calculated UI. For this example, the UI was determined as 0.835. Such determinations may be made at a plurality of times, e.g., at the time of one or more flow rate changes, during pumping of one or more stages in a fracture treatment.

It will be appreciated that the foregoing method may be implemented in any form of programmable computer which is capable of reading a non-transitory computer readable medium having stored on it logic operable to cause the programmable computer to implement the actions described above for determining UI. Thus, another aspect of this disclosure is a non-transitory computer readable medium having such instructions stored on it. FIG. 16 shows an example computing system 600 in accordance with some implementations. Actions described above with reference to example implementations may be carried out on a computer or computer system, wherein pressure measurements made as described may be entered into the computer or computer system and processed in the computer or computer system as explained above. The computing system 600 may be an individual computer system 601A or an arrangement of distributed computer systems. The individual computer system 601A may include one or more analysis modules 602 that may be configured to perform various tasks and controls according to some implementations, such as the tasks explained with reference to FIGS. 2-5. To perform these various tasks, the analysis module 602 may operate independently or in coordination with one or more processors 604, which may be connected to one or more storage media 606. A display device (605) such as a graphic user interface of any known type may be in signal communication with the processor 604 to enable user entry of commands and/or data and to display results of execution of a set of instructions according to the present disclosure.

The processor(s) 604 may also be connected to a network interface 608 to allow the individual computer system 601A to communicate over a data network 610 with sensors, one or more additional individual computer systems and/or computing systems, such as 601B, 601C, and/or 601D. Note that computer systems 601B, 601C and/or 601D may or may not share the same architecture as computer system 601A, and may be located in different physical locations, for example, computer systems 601A and 601B may be at a well drilling location, while in communication with one or more computer systems such as 601C and/or 601D that may be located in one or more data centers on shore, aboard ships, and/or located in varying countries on different continents.

A processor may include, without limitation, a microprocessor, microcontroller, processor module or subsystem, programmable integrated circuit, programmable gate array, or another control or computing device.

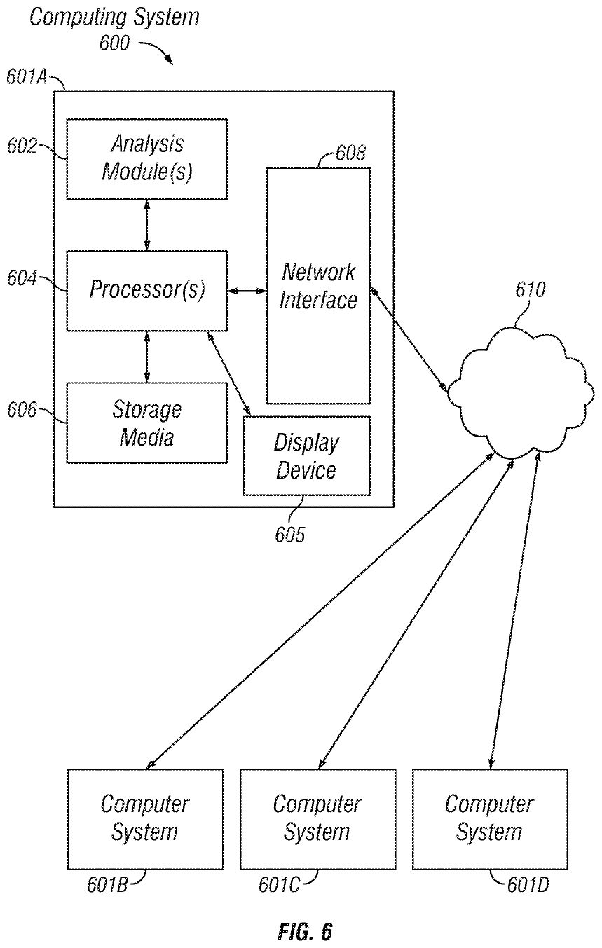

The storage media 606 that captures data in a tangible medium may be implemented as one or more computer-readable or machine-readable storage media. Note that while in the example implementation of FIG. 6 the storage media 606 are shown as being disposed within the individual computer system 601A, in some implementations, the storage media 606 may be distributed within and/or across multiple internal and/or external enclosures of the individual computing system 601A and/or additional computing systems (e.g., 601B, 601C, 601D), or over a network (“cloud”). Storage media 606 may include, without limitation, one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that computer instructions to cause any individual computer system or a computing system to perform the tasks described above may be provided on one computer-readable or machine-readable storage medium, or may be provided on multiple computer-readable or machine-readable storage media distributed in a multiple component computing system having one or more nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions or located at a remote site from which machine-readable instructions can be downloaded over a network for execution.

It should be appreciated that computing system 600 is only one example of a computing system, and that any other implementation of a computing system may have more or fewer components than shown, may combine additional components not shown in the example implementation of FIG. 6, and/or the computing system 600 may have a different configuration or arrangement of the components are shown in FIG. 6. The various components are shown in FIG. 6. may be implemented in hardware, software, or a combination of both hardware and software, including one or more signal processing and/or application specific integrated circuits.

Further, the acts of the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of the present disclosure.

A method for determining UI according to the present disclosure may eliminate the need for sensors outside the well pipe, there being only needed a pressure sensor that may be conveniently located, e.g., near the surface or at surface connected to fluid flow lines into the well.

In light of the principles and example implementations described and illustrated herein, it will be recognized that the example implementations can be modified in arrangement and detail without departing from such principles. The foregoing discussion has focused on specific implementations, but other configurations are also contemplated. In particular, even though expressions such as in “an implementation,” or the like are used herein, these phrases are meant to generally reference implementation possibilities, and are not intended to limit the disclosure to particular implementation configurations. As used herein, these terms may reference the same or different implementations that are combinable into other implementations. As a rule, any implementation referenced herein is freely combinable with any one or more of the other implementations referenced herein, and any number of features of different implementations are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. A method for determining uniformity index (UI) of a fracture treatment, wherein the uniformity index represents a variability of fluid entry into a subsurface formation through each of a multiple perforation clusters in a well pipe, the method comprising:
measuring pressure and fluid flow rate in a well during pumping the fracture treatment;
for at least one change in flow rate of the pumping, determining or estimating a well pipe friction pressure loss; and determining a perforation friction pressure loss using tube wave events in the measured pressure induced by the at least one change in flow rate;
determining a perforation efficiency using the perforation friction pressure loss and an expected perforation friction pressure loss, wherein the expected perforation friction pressure loss is based on hydraulic properties of fluid being pumped and models of fluid flow properties through various size apertures;
determining a volume of fluid accepted by each of a plurality of perforation clusters in the well pipe using the determined perforation efficiency; and
using the determined volumes, calculating the UI.

2. The method of claim 1 further comprising repeating the determining or estimating well pipe and the determining perforation friction pressure loss, repeating the determining perforation efficiency, repeating the determining volume of fluid and repeating the calculating UI for each of a plurality of changes in flow rate during the pumping the fracture treatment.

3. The method of claim 2 further comprising repeating the determining or estimating well pipe friction pressure loss and the determining perforation friction pressure loss, repeating the determining perforation efficiency, repeating the determining volume of fluid and repeating the calculating UI for each of a plurality of changes in flow rate for each of a plurality of fracture treatment stages in the well.

4. The method of claim 1 further comprising repeating the determining or estimating well pipe friction pressure loss and the determining perforation friction pressure loss, repeating the determining perforation efficiency, repeating the determining volume of fluid and repeating the calculating UI for each of a plurality of changes in flow rate for each of a plurality of fracture treatment stages in the well.

5. The method of claim 1 wherein the perforation efficiency is determined as a number of perforations through which fluid is flowing with respect to a total number of perforations in the well pipe.

6. The method of claim 5 wherein the fluid volume for each of the plurality of perforation clusters is determined by the perforation efficiency and a total number of perforations in each of the plurality of perforation clusters.

7. A non-transitory computer readable medium having stored thereon logic operable to cause a programmable computer to perform actions comprising:
accepting as input to the computer, measurements of pressure and fluid flow rate in a well during pumping a fracture treatment;
for at least one change in flow rate of the pumping, determining or estimating a well pipe friction pressure loss, and determining a perforation friction pressure loss using tube wave events in the measured pressure induced by the at least one change in flow rate;
determining a perforation efficiency using the perforation friction pressure loss and an expected perforation friction pressure loss, wherein the expected perforation friction pressure loss is based on hydraulic properties of fluid being pumped and models of fluid flow properties through various size apertures;
determining a volume of fluid accepted by each of a plurality of perforation clusters in the well pipe using the determined perforation efficiency; and
using the determined volumes, calculating a uniformity index (UI) of the plurality of perforation clusters, wherein the uniformity index represents a variability of fluid entry into a subsurface formation through each of a multiple perforation clusters in a well pipe.

8. The computer readable medium of claim 7, wherein the logic further comprises instructions to cause the computer to perform repeating the determining or estimating well pipe friction pressure loss and the determining perforation friction pressure loss, repeating the determining perforation efficiency, repeating the determining volume of fluid and repeating the calculating UI for each of a plurality of changes in flow rate during the pumping the fracture treatment.

9. The computer readable medium of claim 8 wherein the logic further comprises instructions to cause the computer to perform repeating the determining or estimating well pipe friction pressure loss and the determining perforation friction pressure loss, repeating the determining perforation efficiency, repeating the determining volume of fluid and repeating the calculating UI for each of a plurality of changes in flow rate for each of a plurality of fracture treatment stages in the well.

10. The computer readable medium of claim 7 wherein the logic further comprises instructions to cause the computer to perform repeating the determining or estimating well pipe friction pressure loss and the determining perforation friction pressure loss, repeating the determining perforation efficiency, repeating the determining volume of fluid and repeating the calculating UI for each of a plurality of changes in flow rate for each of a plurality of fracture treatment stages in the well.

11. The computer readable medium of claim 7 wherein the perforation efficiency is determined as a number of perforations through which fluid is flowing with respect to a total number of perforations in the well pipe.

12. The computer readable medium of claim 7 wherein the fluid volume for each of the plurality of perforation clusters is determined by the perforation efficiency and a total number of perforations in each of the plurality of perforation clusters.
